(19) United States
(12) Patent Application Publication
(10) Pub. No.: US 2021/0112794 A1
(43) Pub. Date: Apr. 22, 2021

(54) LEADER STRAIGHTENER

(71) Applicant: Joshua Elliott, Richland, WA (US)

(72) Inventor: Joshua Elliott, Richland, WA (US)

(21) Appl. No.: 16/654,006

(22) Filed: Oct. 16, 2019

(51) Int. Cl. A01K 87/04

(52) U.S. Cl. CPC A01K 87/04

(57) ABSTRACT

A leader straightener having a first component disposed about a fishing rod. The first component has a coefficient of friction sufficient to straighten a leader when the leader is pulled through and away from the first component at an angle.

### TECHNICAL FIELD

This invention relates generally to fishing equipment. Among other uses, the present invention may provide an improved leader straightener.

### BACKGROUND OF THE INVENTION

Existing leader straighteners are bulky, cumbersome, and are typically carried by fisherman in their pockets or attached to their clothing. There is a need for leader straighteners that are not bulky and cumbersome, that are more conveniently accessible to fishermen, and that do not have to be carried in a pocket or worn on one's clothing. Existing leader straighteners do not have those capabilities. Among other advantages, and not meant to be limiting, the present invention provides those capabilities.

### SUMMARY OF THE INVENTION

The present invention may include a leader straightener having a first component capable of being disposed about a fishing rod. The first component may have a coefficient of friction sufficient to straighten a leader when the leader is pulled through and away from the first component at an angle. The first component of the leader straightener of the present invention may be generally cylindrical, however, the first component may be any shape that allows it to be disposed about a fishing rod. Such configurations include, but are not limited to any configuration that is multi-sided, curved, or a combination of multi-sided and curved, including without limitation triangular, square, rectangular, round, oval, pentagonal, hexagonal, heptagonal, octagonal, nonagonal, and decagonal configurations and combinations thereof.

Generally, the leader straightener of the present invention may have a coefficient of friction sufficient to straighten a leader when the leader is fed through the leader straightener and pulled at an angle to the leader straightener. Preferably, but not meant to be limiting, the leader straightener of the present invention may have a coefficient of friction sufficient to straighten a leader when the leader is fed through the leader straightener and pulled at an angle of 45 degrees or greater.

While not meant to be limiting, the first component of the leader straightener of the present invention may be made from a material selected from rubber, polyurethane, nitrile butadiene rubber, vinyl, silicon, neoprene, polyisobutylene, synthetic rubber, and combinations thereof.

The first component of the leader straightener may be opened to allow the leader straightener to be disposed about a fishing rod, and also opened to remove the leader straightener from the fishing rod.

The first component of the leader straightener may be further attached to a second component. The second component of the leader straightener may be capable of attaching and removing the leader straightener to a fishing rod. While not meant to be limiting, the second component may be selected as a hook and loop fastener, a button, a buckle, a zipper, a string, and combinations thereof.

The leader straightener may also be configured such that the first component is integral to the fishing rod.

The present invention also includes a method of straightening a leader, which may include the steps of providing a first component capable of being disposed about a fishing rod, wherein the first component may have a coefficient of friction sufficient to straighten a leader when the leader is pulled through and away from the first component at an angle, disposing the first component about a fishing rod, threading a leader through the first component, and pulling the leader against the first component at an angle sufficient to straighten the leader.

The method of the present invention may include the step of providing the first component as generally cylindrical, however, the first component may be provided as any shape that allows it to be disposed about a fishing rod. Such configurations include, but are not limited to any configuration that is multi-sided, curved, or a combination of multi-sided and curved, including without limitation triangular, square, rectangular, round, oval, pentagonal, hexagonal, heptagonal, octagonal, nonagonal, and decagonal configurations and combinations thereof.

Generally, the method of the present invention is accomplished by providing a first component with a coefficient of friction sufficient to straighten a leader when the leader is fed through the first component and pulled at an angle to the first component. Preferably, but not meant to be limiting, the leader straightener of the present invention may have a coefficient of friction sufficient to straighten a leader when the leader is fed through the first component and pulled at an angle of 45 degrees or greater.

While not meant to be limiting, the first component of the leader straightener of the method of the present invention may be provided as a material selected from rubber, polyurethane, nitrile butadiene rubber, vinyl, silicon, neoprene, polyisobutylene, synthetic rubber, and combinations thereof.

The method of the present invention may further include a step where the first component of the leader straightener is opened and the leader straightener is disposed about a fishing rod, and/or the step where the leader straightener is opened to remove the leader straightener from the fishing rod.

Within the method of the present invention, the first component of the leader straightener may be provided as being attached to a second component. The second component of the leader straightener may be provided as being capable of attaching and removing the leader straightener to a fishing rod. While not meant to be limiting, the second component may be selected as a hook and loop fastener, a button, a buckle, a zipper, a string, and combinations thereof.

The method of the present invention may also include the step of providing the leader straightener such that the first component is integral to the fishing rod.

### BRIEF DESCRIPTION OF THE DRAWINGS

The following detailed description of the embodiments of the invention will be more readily understood when taken in conjunction with the following drawing, wherein:

FIG. 1 is a drawing of an illustrative embodiment of the present invention.

FIG. 2A is a drawing of an illustrative embodiment of the present invention showing the leader straightener flattened out from a bottom perspective.

FIG. 2B is a drawing of an illustrative embodiment of the present invention showing the leader straightener flattened out from a side perspective.

FIG. 2C is a drawing of an illustrative embodiment of the present invention showing the leader straightener coiled from an end perspective.

FIG. 3 is a drawing of an illustrative embodiment of the present invention showing the leader straightener as an integral component of a fishing rod.

### DETAILED DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitations of the inventive scope is thereby intended, as the scope of this invention should be evaluated with reference to the claims appended hereto. Alterations and further modifications in the illustrated devices, and such further applications of the principles of the invention as illustrated herein are contemplated as would normally occur to one skilled in the art to which the invention relates.

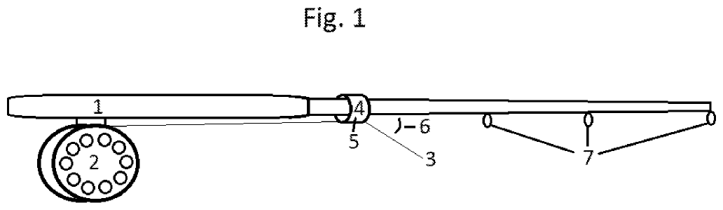

One exemplary embodiment of the present invention is shown in FIG. 1, wherein the present invention is used on a fly fishing rig. As will be apparent to those having ordinary skill in the art of fly fishing, the line used for fly fishing is not consistent the entire length from the reel to the fly which contains the hook on a fly fishing rig. Typically, the majority of the line used for fly fishing is relatively heavy weight, typically this is called “fly line,” which assists the back and forth whip motion that is used to cast the fly out from the fisherman onto the water. It is undesirable to tie the fly to this heavy line however, because the fish are less likely to strike a fly tied to a heavy, and therefore more visible, line. Fly fishermen solve this problem by interposing a “leader” in between the heavy line and the fly. The leader consists of a relatively light section of fishing line that is less visible to the fish. Additionally, the leader may also include tippet, which is used to tie flies to the leader. As used herein, “leader” includes any tippet. Unfortunately, leaders are typically sold as a coil which causes the leader to present a coiled configuration if not first straightened. Even leaders that have been straightened will assume a coiled configuration if left on a reel for a period of time. Fly fishermen understand this coiled configuration on the water is undesirable, as it leads to fewer strikes from fish. Thus, fly fishermen seek to straighten the leader, to eliminate the coiled presentation on the water. The present invention shown in FIG. 1 solves that problem in a manner that is superior to prior art leader straighteners.

As shown in FIG. 1, the present invention utilizes a typical fishing rod 1 and reel 2. The leader 3 is threaded through the leader straightener 4 of the present invention. By pulling on the leader 3 at an angle 6, the coiled leader may thereby be straightened. As shown in FIG. 1, the leader straightener 4 is made of a first component 5 capable of being disposed about the fishing rod 1 that has a coefficient of friction sufficient to straighten a leader 3 when the leader 3 is pulled through and away from the first component 5 of the leader straightener 4 at an angle 6. As shown in FIG. 1, this is typically accomplished when leader 3 is not threaded through eyelets 7 of fishing rod 1, but those having ordinary skill in the art could certainly do so if desired.

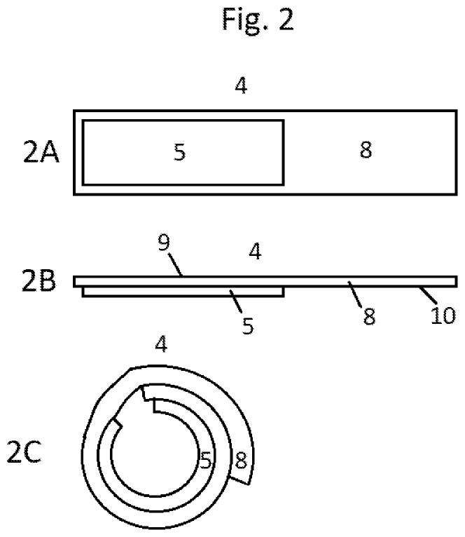

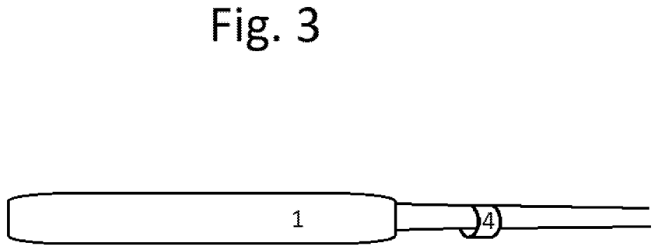

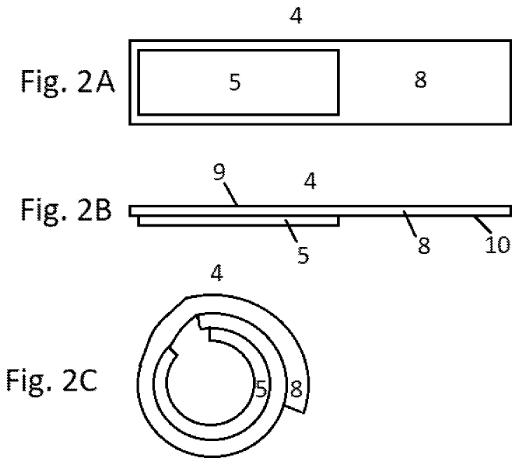

FIG. 2 shows multiple views of the leader straightener 4 away from fishing rod 1 and reel 2 of FIG. 1. FIGS. 2A and 2B shows the leader straightener 4 flattened out from a bottom and side perspective. As shown in FIGS. 2A and 2B, leader straightener 4 consists of a first component 5 and a second component 8. In the illustrative example of FIGS. 2A and 2B, the second component 8 is made of a hook and loop fastener, commonly known as velcro. As shown in FIGS. 2A and 2B, the second component 8 has a loop surface 9 and an opposing hook surface 10, although those having ordinary skill in the art will recognize that the present invention could readily be configured with the loop surface 9 and an opposing hook surface 10 reversed.

FIG. 2C shows the leader straightener 4 coiled about itself, as it would be configured when disposed about a fishing rod 1 as shown in FIG. 1, from an end perspective. As shown in FIG. 1, a fishing rod 1 will taper in diameter along the length of the fishing rod 1. The fisherman can leave the leader straightener 4 in place by fitting snugly near the base of the fishing rod 1. This allows the fisherman to keep the leader straightener 4 on the fishing rod 1, but secured while fishing. By sliding the leader straightener 4 away from the base of fishing rod 1 as needed, it allows the fisherman an opening to thread the leader through the leader straightener 4. As shown in FIG. 2C, the loop surface 9 and the opposing hook surface 10 are in contact with one and another, thereby holding the leader straightener 4 coiled about itself. In this position, and when disposed about a fishing rod 1, leader straightener 4 is available to have a leader threaded through it, and by applying force at an angle, a user may thereby straighten the leader.

FIG. 3 shows the leader straightener 4 of the present invention as an integral component of fishing rod 1. As shown in the Figure, but not meant to be limiting, the leader straightener 4 is an integral component of fishing rod 1 and, as such, is permanently affixed to fishing rod 1, and is thereby not removable as it is in the other embodiments described herein.

While the invention has been illustrated and described in detail in the drawings and foregoing description, the same is to be considered as illustrative and not restrictive in character. Only certain embodiments have been shown and described, and all changes, equivalents, and modifications that come within the spirit of the invention described herein are desired to be protected. Any experiments, experimental examples, or experimental results provided herein are intended to be illustrative of the present invention and should not be considered limiting or restrictive with regard to the invention scope. Further, any theory, mechanism of operation, proof, or finding stated herein is meant to further enhance understanding of the present invention and is not intended to limit the present invention in any way to such theory, mechanism of operation, proof, or finding.

Thus, the specifics of this description and the attached drawings should not be interpreted to limit the scope of this invention to the specifics thereof. Rather, the scope of this invention should be evaluated with reference to the claims appended hereto. In reading the claims it is intended that when words such as “a”, “an”, “at least one”, and “at least a portion” are used there is no intention to limit the claims to only one item unless specifically stated to the contrary in the claims. Further, when the language “at least a portion” and/or “a portion” is used, the claims may include a portion and/or the entire items unless specifically stated to the contrary. Finally, all publications, patents, and patent applications cited in this specification are herein incorporated by reference to the extent not inconsistent with the present disclosure as if each were specifically and individually indicated to be incorporated by reference and set forth in its entirety herein.

I claim:

1) A leader straightener comprising:
a first component capable of being disposed about a fishing rod having an coefficient of friction sufficient to straighten a leader when said leader is pulled through and away from said first component at an angle.

2) The leader straightener of claim 1 wherein the first component is cylindrical.

3) The leader straightener of claim 1 wherein the angle is 45 degrees or greater.

4) The leader straightener of claim 1 wherein the first component is made from a material selected from rubber, polyurethane, nitrile butadiene rubber, vinyl, silicon, neoprene, polyisobutylene, synthetic rubber, and combinations thereof.

5) The leader straightener of claim 1 wherein the first component is capable of being opened to allow the leader straightener to be disposed about a fishing rod.

6) The leader straightener of claim 5 wherein the first component is further attached to a second component.

7) The leader straightener of claim 6 wherein the second component is capable of attaching and removing the leader straightener to a fishing rod.

8) The leader straightener of claim 6 wherein the second component is selected as a hook and loop fastener, a button, a buckle, a zipper, a string, and combinations thereof.

9) The leader straightener of claim 1 wherein the first component is made integral to the fishing rod.

10) A method of straightening a leader comprising the steps of
providing a material capable of being disposed about a fishing rod, said material having an coefficient of friction sufficient to straighten a leader when said leader is pulled through and away from said material at an angle,
disposing said material about a fishing rod,
threading a leader through said material,
pulling said leader against said material at an angle sufficient to straighten said leader.

11) The method of claim 10 wherein the first component is provided as cylindrical.

12) The method of claim 10 wherein the angle is 45 degrees or greater.

13) The method of claim 10 wherein the first component is provided as having been made from a material selected from rubber, polyurethane, nitrile butadiene rubber, vinyl, silicon, neoprene, polyisobutylene, synthetic rubber, and combinations thereof.

14) The method of claim 10 wherein the first component is opened to allow the leader straightener to be disposed about a fishing rod.

15) The method of claim 14 wherein the first component is provided as attached to a second component.

16) The method of claim 15 wherein the second component attaches the leader straightener to a fishing rod.

17) The method of claim 15 wherein the second component is selected as a hook and loop fastener, a button, a buckle, a zipper, a string, and combinations thereof.

18) The method of claim 10 wherein the first component is provided as integral to the fishing rod.
